(19) United States
(12) Patent Application Publication
(10) Pub. No.: US 2026/0270940 A1
(43) Pub. Date: Sep. 10, 2026

(54) INFORMATION PROCESSING APPARATUS, INFORMATION PROCESSING METHOD, LPWA COMMUNICATION TERMINAL, COMMUNICATION METHOD, AND PROGRAM

(71) Applicant: SONY SEMICONDUCTOR SOLUTIONS CORPORATION, KANAGAWA (JP)

(72) Inventors: KENTARO NAKAHARA, KANAGAWA (JP); TETSUHIRO FUTAMI, KANAGAWA (JP); HIDEYA KITAYAMA, KANAGAWA (JP)

(21) Appl. No.: 19/167,002

(22) PCT Filed: Mar. 1, 2024
(86) PCT No.: PCT/JP2024/007727

§ 371 Date: Sep. 19, 2025

(30) Foreign Application Priority Data
Mar. 28, 2023 (JP) 2023-050941

(51) Int. Cl. H04W 64/00; G01S 19/25

(52) U.S. Cl. CPC H04W 64/00; G01S 19/25

(57) ABSTRACT

The present technology particularly relates to an information processing apparatus, an information processing method, an LPWA communication terminal, a communication method, and a program capable of providing appropriate GNSS assist information for the LPWA communication terminal.

An information processing apparatus according to an aspect of the present technology generates GNSS assist information that is used in an LPWA communication terminal to receive a satellite signal and that includes information according to a situation of the LPWA communication terminal, and transmits the GNSS assist information to the LPWA communication terminal within an area using LPWA communication. The present technology can be applied to a wireless communication network capable of downlink LPWA communication.

### TECHNICAL FIELD

The present technology particularly relates to an information processing apparatus, an information processing method, an LPWA communication terminal, a communication method, and a program capable of providing appropriate GNSS assist information for the LPWA communication terminal.

### BACKGROUND ART

As applications using low power wide area (LPWA) communication, there are applications for tracking positions of persons, vehicles, and the like. In this case, LPWA communication terminals equipped with a global navigation satellite system (GNSS) receiver are prepared for the persons and vehicles to be tracked. Position information is transmitted from the LPWA communication terminals to base stations, for example, at a constant cycle.

### CITATION LIST

### Patent Document

Patent Document 1: Japanese Patent Application Laid-Open No. 2009-85725
Patent Document 2: Japanese Patent Application Laid-Open No. 2003-43127

### SUMMARY OF THE INVENTION

### Problems to be Solved by the Invention

Some LPWA communication standards are being considered for introduction of a downlink communication function. In a case where communication in a direction from an LPWA communication terminal to a base station used for transmission of position information as described above is uplink communication, downlink communication is communication in a direction from a base station to an LPWA communication terminal. By preparing the downlink communication function, various types of information can be provided from a base station side for each LPWA communication terminal.

Meanwhile, as a mobile communication technology, there is an assisted GNSS (A-GNSS) that assists acquisition of position information by a GNSS receiver. For example, information used to shorten an acquisition time of position information is provided from a server for a terminal, such as a smartphone, equipped with a GNSS receiver by mobile communication.

Although it is conceivable to apply a conventional A-GNSS technology to LPWA communication with the downlink communication function, the technology cannot be applied as it is because the amount of transmission by LPWA communication is limited.

The present technology has been made in view of such circumstances, and an object thereof is to provide appropriate GNSS assist information for an LPWA communication terminal.

### Solutions to Problems

An information processing apparatus according to an aspect of the present technology includes a generation unit that generates GNSS assist information that is used in an LPWA communication terminal to receive a satellite signal and that includes information according to a situation of the LPWA communication terminal, and an LPWA communication unit that transmits the GNSS assist information to the LPWA communication terminal within an area using LPWA communication.

An LPWA communication terminal according to another aspect of the present technology includes an LPWA communication unit that receives GNSS assist information generated in an LPWA base station in such a way as to include information according to a situation of an LPWA communication terminal and transmitted by the LPWA base station using LPWA communication, and a GNSS reception unit that receives a satellite signal on the basis of information included in the GNSS assist information.

According to the one aspect of the present technology, GNSS assist information that is used in an LPWA communication terminal to receive a satellite signal and that includes information according to a situation of the LPWA communication terminal is generated, and the GNSS assist information is transmitted to the LPWA communication terminal within an area using LPWA communication.

According to the other aspect of the present technology, GNSS assist information generated in an LPWA base station in such a way as to include information according to a situation of an LPWA communication terminal and transmitted by the LPWA base station using LPWA communication is received, and a satellite signal is received on the basis of information included in the GNSS assist information.

### BRIEF DESCRIPTION OF DRAWINGS

FIG. 1 is a diagram illustrating a configuration example of a communication system according to an embodiment of the present technology.

FIG. 2 is a diagram illustrating a procedure of time synchronization in the communication system.

FIG. 3 is a diagram illustrating a specific example of time calculation by an LPWA communication terminal.

FIG. 4 is a diagram illustrating frame configuration of a GPS.

FIG. 5 is a diagram illustrating an example of movement of a satellite.

FIG. 6 is a block diagram illustrating a configuration example of an information processing apparatus included in an LPWA base station.

FIG. 7 is a block diagram illustrating a configuration example of the LPWA communication terminal.

FIG. 8 is a flowchart illustrating a process by the LPWA base station.

FIG. 9 is a flowchart illustrating a satellite selection process performed in step S2 in FIG. 8.

FIG. 10 is a flowchart illustrating a process by the LPWA communication terminal.

FIG. 11 is a diagram illustrating an example of adaptive control of GNSS assist information.

FIG. 12 is a diagram illustrating a specific example of contract forms.

FIG. 13 is a flowchart illustrating a process by the LPWA base station that generates the GNSS assist information on the basis of contract forms of terminals within an area.

FIG. 14 is a diagram illustrating an example of the GNSS assist information for each of groups of LPWA communication terminals.

FIG. 15 is a flowchart illustrating a process by the LPWA base station that generates the GNSS assist information on the basis of reception environments of the terminals within the area.

FIG. 16 is a diagram illustrating a specific example of the reception environments.

FIG. 17 is a diagram illustrating an example of the GNSS assist information for each of the groups of the LPWA communication terminals.

FIG. 18 is a flowchart illustrating a process by the LPWA base station that transmits hierarchized GNSS assist information.

FIG. 19 is a diagram illustrating an example of transmission of the hierarchized GNSS assist information.

FIG. 20 is a diagram illustrating an example of the GNSS assist information for each of the groups of the LPWA communication terminals.

FIG. 21 is a block diagram illustrating another configuration example of the LPWA communication terminal.

FIG. 22 is a flowchart illustrating a process by the LPWA communication terminal having the configuration illustrated in FIG. 21.

FIG. 23 is a block diagram illustrating a configuration example of a computer.

### MODE FOR CARRYING OUT THE INVENTION

Modes for carrying out the present technology will be described hereinafter. The description will be given in the following order.
1. First Embodiment: Highly Accurate Time Synchronization Method at Time of One-Satellite Reception
2. Second Embodiment: Adaptive Control of Amount of Information of GNSS Assist Information
3. Others

### First Embodiment: Highly Accurate Time Synchronization Method at Time of One-Satellite Reception

### <Configuration of Communication System>

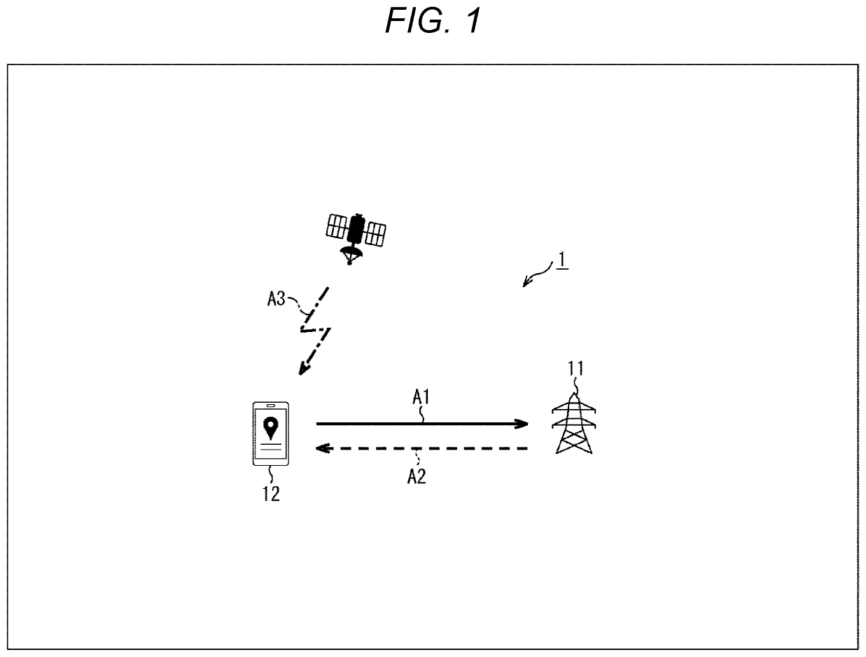

FIG. 1 is a diagram illustrating a configuration example of a communication system according to an embodiment of the present technology.

A communication system 1 in FIG. 1 is a wireless communication system using low power wide area (LPWA) communication. The LPWA communication is performed using, for example, a 920 MHz band in Japan. An LPWA base station 11 receives data transmitted by the LPWA communication terminal 12 within a coverage area. The coverage area managed by the LPWA base station 11 is, for example, an area having a radius of 10 km.

In the example of FIG. 1, the LPWA communication terminal 12, which is a smartphone, is illustrated as a terminal within the coverage area of the LPWA base station 11, but in practice, more LPWA communication terminals are provided, which are LPWA transmitters.

While the LPWA base station 11 is an apparatus fixedly installed on a rooftop of a building, a utility pole, or the like, the LPWA communication terminal 12 is, for example, a device carried by a user or attached to a mobile body such as an automobile. A position of the LPWA communication terminal 12 can move. An installation position of the LPWA communication terminal 12 might be fixed.

In the LPWA communication of the communication system 1, not only an uplink communication function as indicated by an arrow A1 but also a downlink communication function as indicated by an arrow A2 is prepared. Communication in the direction from the LPWA communication terminal 12 to the LPWA base station 11 is uplink communication, and communication in the direction from the LPWA base station 11 to the LPWA communication terminal 12 is downlink communication.

Since the downlink communication function is provided, the LPWA base station 11 can provide various types of information for each of the LPWA communication terminals within the area including the LPWA communication terminal 12.

Collectively transmitting the same information to all the LPWA communication terminals in the coverage area using downlink communication will be referred to as LPWA broadcasting hereinafter as appropriate. As downlink communication modes, for example, an LPWA broadcasting mode, a group communication mode, and a one-to-one communication mode are prepared. The group communication is a mode of transmitting the same information to a plurality of specific LPWA communication terminals constituting the same group. The one-to-one communication mode is a mode for transmitting information to a specific LPWA communication terminal.

ELTRES (registered trademark) is one of LPWA communication standards. The amount of transmission in one uplink communication of the ELTRES is 128 bits. For example, the same 128 bits are secured as the amount of transmission in downlink communication.

The LPWA communication terminal 12 is a terminal equipped with a reception module of a global navigation satellite system (GNSS). The GNSS includes GPS, QZSS, Galileo, BeiDou, GLONASS, and the like.

The LPWA communication terminal 12 receives satellite signals that are signals of GNSS satellites as indicated by an arrow A3, and acquires position information (performs positioning). Note that the LPWA communication terminal 12 needs to receive signals of at least four satellites in order to acquire position information and a highly accurate time.

The LPWA communication terminal 12 transmits the position information acquired on the basis of the satellite signals to the LPWA base station 11 together with information such as a device ID, which is identification information regarding the LPWA communication terminal 12. The position information received by the LPWA base station 11 is transmitted from the LPWA base station 11 to a server (not illustrated), for example, and is managed in association with the device ID. A server is connected to the LPWA base station 11 via a network such as the Internet.

As described above, the LPWA communication terminal 12 is not only an LPWA transmitter but also a GNSS receiver. In addition, the LPWA communication used in the communication system 1 of FIG. 1 is LPWA communication capable of not only uplink communication but also downlink communication.

In order to perform LPWA communication between the LPWA base station 11 and the LPWA communication terminal 12, time in the LPWA base station 11 and time in the LPWA communication terminal 12 need to be synchronized. The time synchronization of the LPWA base station 11 is performed on the basis of time information included in the satellite signals. The LPWA base station 11 receives the satellite signals and establishes the time synchronization with the LPWA communication terminal 12 within the coverage area. An accurate time used for the time synchronization of the LPWA base station 11 may be acquired from the server (not illustrated).

### <Time Synchronization Method>

Although it is necessary to receive signals of at least four satellites in order to acquire a highly accurate time, a rough time having an error of about several tens of ms can be acquired with a signal of only one satellite. This error is an error due to a fact that a component of a propagation delay cannot be compensated with a signal of one satellite.

In order to perform LPWA communication between the LPWA base station 11 and the LPWA communication terminal 12, time synchronization needs to be established, but time synchronization cannot be established using a time that can be acquired on the basis of a signal of one satellite. For example, in the case of the ELTRES, time accuracy of ±300 μs is required (an error between the time in the LPWA base station 11 and the time in the LPWA communication terminal 12 needs to be within ±300 μs).

In the communication system 1, GNSS assist information, which is information for enabling time synchronization of LPWA communication to be established only by receiving a signal of one satellite, is provided for the LPWA communication terminal 12 using downlink communication. The GNSS assist information is information for the LPWA communication terminal 12 in a situation of establishing time synchronization of the LPWA communication.

The GNSS assist information provided using the downlink communication is information with a smaller amount of information than assist information used in the conventional A-GNSS. Since the amount of transmission is limited, the assist information used in the conventional A-GNSS cannot be transmitted as it is by downlink communication. In a case where the amount of transmission in one downlink communication is 128 bits as described above, the assist information in the conventional A-GNSS having an amount of information of about 2 kbits cannot be transmitted as it is.

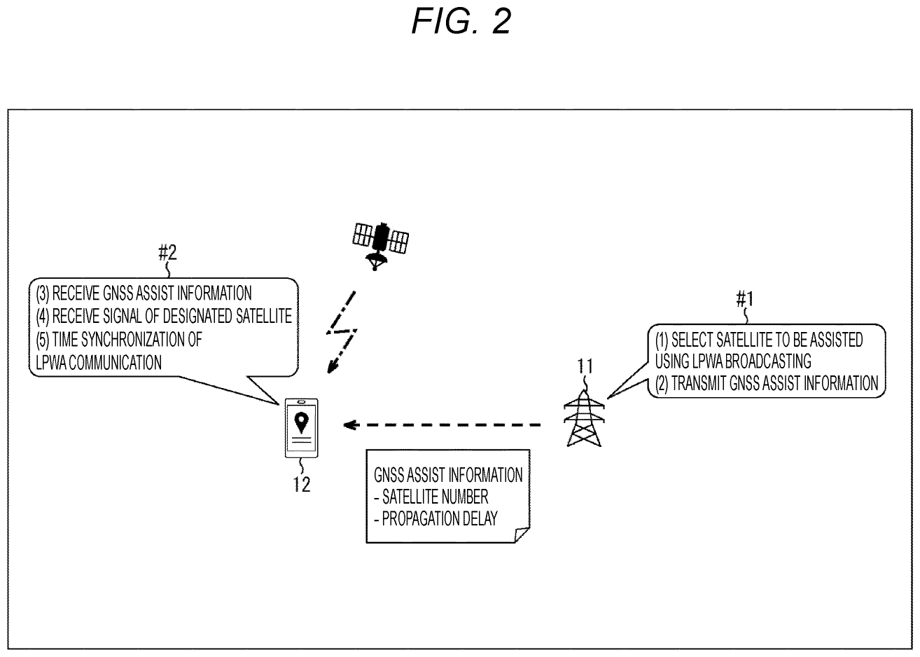

FIG. 2 is a diagram illustrating a procedure of the time synchronization in the communication system.

As illustrated in a balloon #1, the LPWA base station 11 selects a satellite to be assisted using LPWA broadcasting. Assisting a satellite means providing information regarding the satellite. Details of a series of processing steps including the selection of a satellite will be described later. The LPWA base station 11 generates GNSS assist information including the information regarding the selected satellite, and transmits the GNSS assist information to the LPWA communication terminal 12 using LPWA broadcasting.

As illustrated in FIG. 2, the GNSS assist information includes information regarding a satellite number (pseudo random noise (PRN)) and a propagation delay. For example, 8 bits are assigned to the satellite number, which is an identification number of a satellite unique code. In addition, for example, 11 bits are assigned to the propagation delay as the number of bits in consideration of a delay due to the ionosphere and the like. Since the amount of information is small, the GNSS assist information is information that can be transmitted by LPWA communication.

For example, a GPS satellite at a zenith has an altitude of about 20,200 km from a ground surface. In this case, the propagation delay is obtained as 67.38 ms through a division by the speed of light. When 67.38 ms is quantized by 100 μs, a value of 674 is obtained. For example, a numerical value of 674 is transmitted as the information regarding the propagation delay of the GNSS assist information.

As illustrated in a balloon #2, the LPWA communication terminal 12 receives the GNSS assist information transmitted from the LPWA base station 11 by LPWA broadcasting, and receives a signal of the satellite designated by the satellite number included in the GNSS assist information. The LPWA communication terminal 12 establishes the time synchronization on the basis of a reception timing of the satellite signal and the propagation delay included in the GNSS assist information. For example, a transmission timing of the satellite signal is obtained by subtracting a time corresponding to the propagation delay from the reception timing of the satellite signal, and the time synchronization is established.

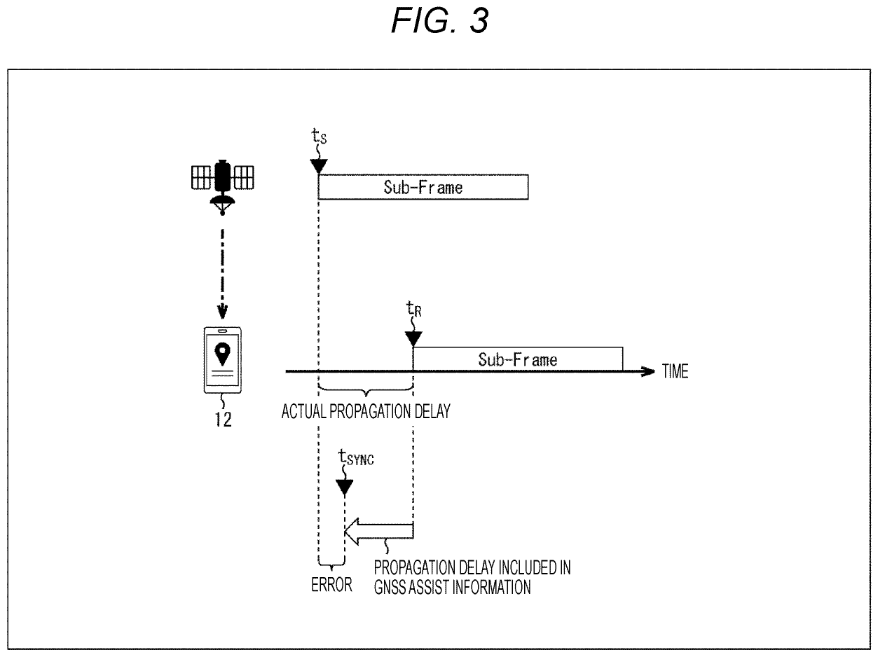

FIG. 3 is a diagram illustrating a specific example of time calculation by the LPWA communication terminal 12.

As illustrated in an upper part of FIG. 3, a transmission timing of subframes of the satellite designated by the satellite number of the GNSS assist information is a time t_{S}, and a reception timing of the subframes by the LPWA communication terminal 12 is a time t_{R}. In this case, a time before the time t_{R} by the time corresponding to the propagation delay indicated by a hollow arrow is obtained as a time t_{SYNC}, which is a synchronization time. The time t_{Sync} is represented by the following expressions (1) and (2).

$${t}_{SYNC} = {t}_{R} - propagation delay \qquad ( 1 )$$

$${t}_{SYNC} = {t}_{S} + error \qquad ( 2 )$$

As illustrated in FIG. 3, an error occurs between the time t_{S} and the time t_{SYNC}. An error factor includes a quantization error (in a case where quantization accuracy is 100 μs, a maximum of 100 μs) of the propagation delay, a propagation delay error due to the troposphere and the like, a satellite orbit error, and the like.

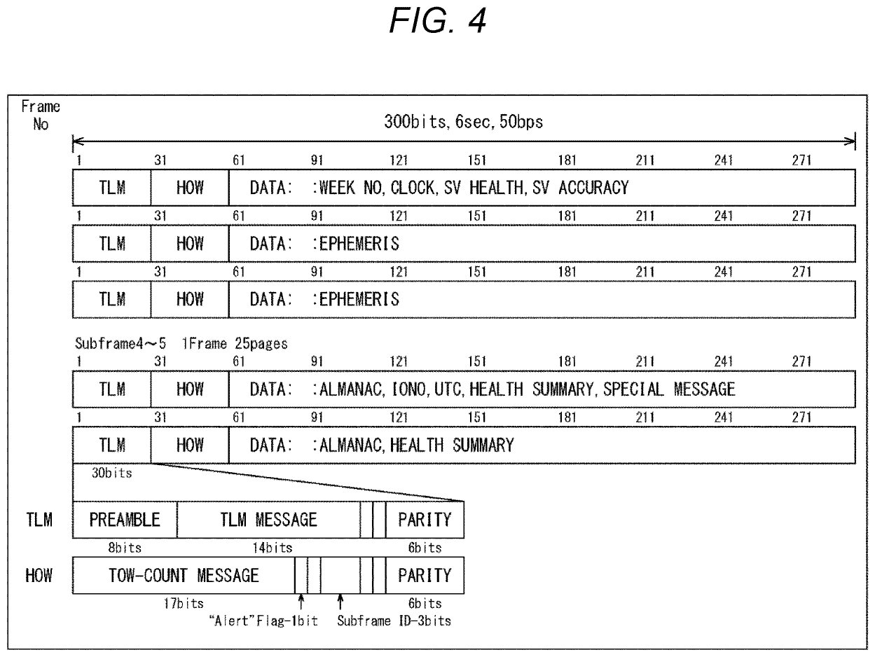

FIG. 4 is a diagram illustrating frame configuration of the GPS.

As illustrated in FIG. 4, one subframe is 300-bit (6-sec) information. The time synchronization in FIG. 3 is assumed to use subframe synchronization. A TLM word is arranged at a head of each subframe. Subframe synchronization can be established using a TLM word (0.6 sec) with a preamble.

Note that it is possible to identify hour, minute, and second by receiving up to a time of week of a HOW word following the TLM word. Identifying hour, minute, and second is sufficient for ELTRES communication.

### Time Synchronization Accuracy

In the case of ELTRES, accuracy of +300 μs is required as accuracy of time synchronization. The time acquired on the basis of a signal of one satellite in the communication system 1 can be used for the time synchronization of the ELTRES until position coordinates of the satellite move by 90 km. 90 km, which is an allowable value of a change in the position coordinates, is obtained from the following expression (3).

$$\pm 300 μs \times light speed = 90 km \qquad ( 3 )$$

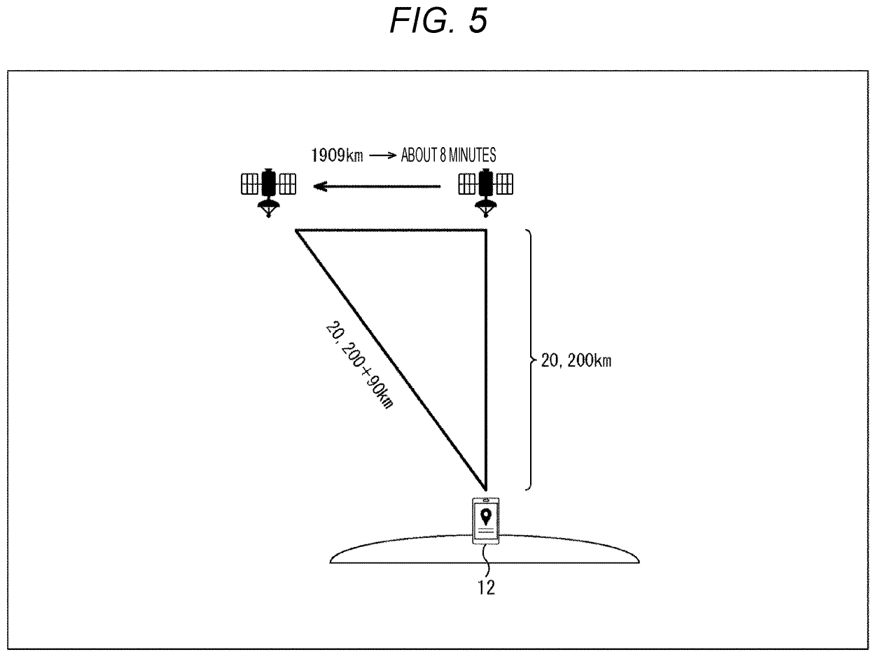

For example, velocity of a GPS satellite is about 3.874 km/s. Time taken for the position coordinates of the satellite to move 90 km is about 8 minutes as illustrated in FIG. 5. The GNSS assist information provided by the LPWA broadcasting can be used for the time synchronization for a certain period of time such as about 8 minutes. A time that can be used for the time synchronization is set as an expiration time of the GNSS assist information.

### Satellite Selection

In a case where a GPS satellite is at the zenith, a path difference of 90 km occurs in about 8 minutes. A satellite with a higher elevation angle is less likely to cause an error in time synchronization. The selection of the satellite to be assisted by LPWA broadcasting is performed in such a way as to select a satellite with a higher elevation angle.

QZSS and BeiDou include geostationary satellites. In the case of a geostationary satellite, a path difference due to satellite movement hardly occurs. In a case where a signal of a geostationary satellite is used for the time synchronization as described above, the expiration time of the GNSS assist information can be considered as substantially infinite. The selection of the satellite to be assisted by LPWA broadcasting is performed in such a way as to select a geostationary satellite in a case where there are geostationary satellites.

As described above, the selection of the satellite to be assisted by the LPWA broadcasting is performed in such a way to as select a satellite with which a GNSS receiver side (an LPWA communication terminal 12 side) can easily receive a satellite signal and whose distance to the GNSS receiver hardly changes. Examples of the satellite with which the GNSS receiver side can easily receive a satellite signal include a satellite with a high elevation angle and a satellite with a high CNR. In addition, examples of the satellite whose distance to the GNSS receiver hardly changes include a satellite with a high elevation angle and a satellite whose satellite orbit is close to a geostationary orbit. In a case where there are geostationary satellites, a geostationary satellite is selected.

A series of processing steps of the communication system 1 for establishing time synchronization on the basis of the GNSS assist information will be described later with reference to a flowchart.

### <Configuration of Each Apparatus>

### Configuration of LPWA Base Station 11

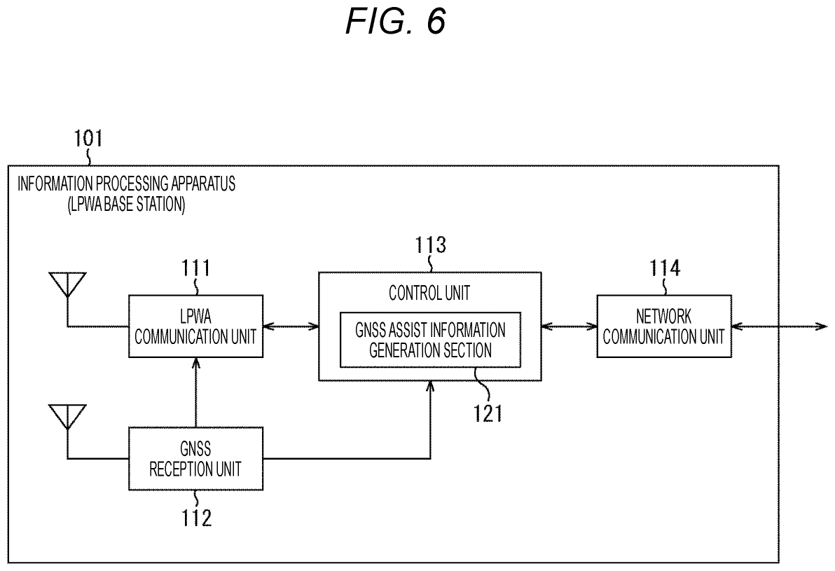

FIG. 6 is a block diagram illustrating a configuration example of an information processing apparatus 101 included in the LPWA base station 11. The information processing apparatus 101 implemented by a computer or the like is provided in the LPWA base station 11.

As illustrated in FIG. 6, the information processing apparatus 101 includes an LPWA communication unit 111, a GNSS reception unit 112, a control unit 113, and a network communication unit 114.

The LPWA communication unit 111 receives data such as position information transmitted from the LPWA communication terminal 12 according to parameters supplied from the control unit 113. Information such as a time division multiplexing parameter, a frequency division multiplexing parameter, and a synchronization pattern is set by the control unit 113.

The LPWA communication unit 111 outputs the received sensor data to the control unit 113.

In addition, the LPWA communication unit 111 transmits the GNSS assist information supplied from the control unit 113 using LPWA broadcasting.

The GNSS reception unit 112 receives a satellite signal and outputs time information included in the satellite signal to the LPWA communication unit 111. The time information is also appropriately supplied to the control unit 113. The signal output from the GNSS reception unit 112 establishes time synchronization of LPWA communication with the LPWA communication terminal 12.

The control unit 113 includes a central processing unit (CPU), a read only memory (ROM), and a random access memory (RAM). The control unit 113 executes a predetermined program and controls an entire operation of the information processing apparatus 101. For example, the control unit 113 acquires the position information received by the LPWA communication unit 111 and outputs the position information to the network communication unit 114.

By executing the predetermined program, a GNSS assist information generation section 121 is achieved in the control unit 113. The GNSS assist information generation section 121 generates GNSS assist information including information regarding a satellite number and a transmission delay, and outputs the GNSS assist information to the LPWA communication unit 111.

The network communication unit 114 is an interface of the Internet. The network communication unit 114 communicates with each of apparatuses connected to the Internet. For example, the network communication unit 114 transmits the position information supplied from the control unit 113 to the server together with a device ID.

### Configuration of LPWA Communication Terminal 12

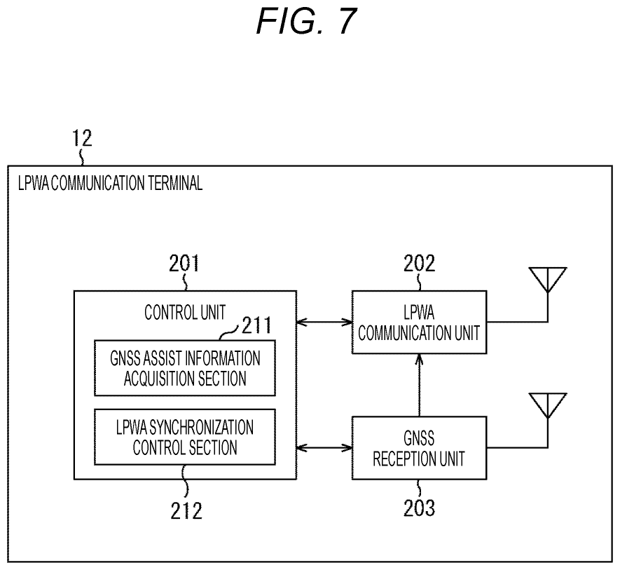

FIG. 7 is a block diagram illustrating a configuration example of the LPWA communication terminal 12.

As illustrated in FIG. 7, the LPWA communication terminal 12 includes a control unit 201, an LPWA communication unit 202, and a GNSS reception unit 203.

The control unit 201 includes a CPU, a ROM, a RAM, and the like. The control unit 201 executes a predetermined program and controls an entire operation of the LPWA communication terminal 12. For example, the control unit 201 generates transmission data that is data to be transmitted to the LPWA base station 11 using LPWA communication. For example, in the case of transmitting position information, the control unit 201 generates transmission data including the position information supplied from the GNSS reception unit 203. The transmission data includes the device ID of the LPWA communication terminal 12.

Data other than the position information, such as an image, a sound, a temperature, humidity, acceleration, angular velocity, and illuminance may be transmitted. In this case, the control unit 201 acquires these pieces of data detected by sensors provided in the LPWA communication terminal 12, and generates transmission data. The transmission data generated by the control unit 201 is output to the LPWA communication unit 202.

By executing the predetermined program, a GNSS assist information acquisition section 211 and an LPWA synchronization control section 212 are achieved in the control unit 201.

The GNSS assist information acquisition section 211 acquires GNSS assist information transmitted from the LPWA base station 11 using LPWA broadcasting. The GNSS assist information acquisition section 211 outputs a satellite number included in the GNSS assist information to the GNSS reception unit 203 to start receiving a satellite signal.

In a case where a signal of a satellite designated by the satellite number included in the GNSS assist information is received by the GNSS reception unit 203, the LPWA synchronization control section 212 calculates a synchronization time on the basis of a reception timing of the satellite signal and a propagation delay included in the GNSS assist information. The LPWA synchronization control section 212 outputs information regarding the synchronization time to the LPWA communication unit 202 to establish time synchronization.

The LPWA communication unit 202 establishes time synchronization under the control of the control unit 201 or on the basis of a 1PPS signal supplied from the GNSS reception unit 203. The LPWA communication unit 202 transmits the transmission data generated by the control unit 201 to the LPWA base station 11. In addition, the LPWA communication unit 202 outputs, using LPWA broadcasting, the GNSS assist information transmitted from the LPWA base station 11 to the control unit 201.

The GNSS reception unit 203 receives a satellite signal and outputs a pulse per second (1PPS) signal to the LPWA communication unit 202. Furthermore, the GNSS reception unit 203 performs positioning by receiving a satellite signal, and outputs position information regarding the LPWA communication terminal 12 to the control unit 201.

### <Operation of Each Apparatus>

Operations of the LPWA base station 11 and the LPWA communication terminal 12 having the above-described configurations will be described.

### Operation of LPWA Base Station 11

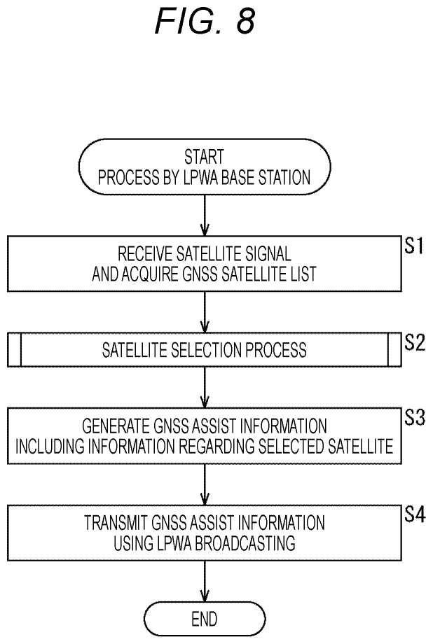

A process by the LPWA base station 11 will be described with reference to a flowchart of FIG. 8.

In step S1, the GNSS reception unit 112 in FIG. 6 receives a satellite signal and acquires a GNSS satellite list. A satellite whose information is to be included in the GNSS assist information is selected from GNSS satellites from which the GNSS reception unit 112 can receive satellite signals.

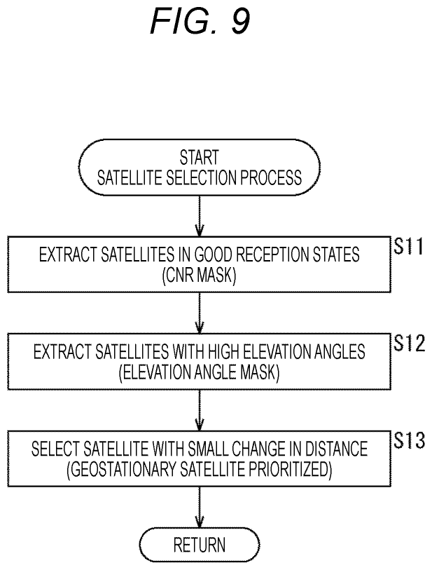

In step S2, the GNSS assist information generation section 121 of the control unit 113 performs the satellite selection process. The satellite selection process performed in step S2 will be described later with reference to a flowchart of FIG. 9.

In step S3, the GNSS assist information generation section 121 generates GNSS assist information including information regarding the selected satellite.

In step S4, the LPWA communication unit 111 transmits the GNSS assist information using LPWA broadcasting.

The satellite selection process performed in step S2 in FIG. 8 will be described with reference to the flowchart of FIG. 9.

In step S11, the GNSS assist information generation section 121 extracts satellites in good reception states (CNR mask).

In step S12, the GNSS assist information generation section 121 extracts satellites with high elevation angles (elevation angle mask).

In step S13, the GNSS assist information generation section 121 selects a satellite with a small change in distance (geostationary satellite prioritized).

As described above, a satellite whose information is to be included in the GNSS assist information is selected on the basis of at least one of a reception state of a satellite signal, an elevation angle of a GNSS satellite, and a degree of change in the distance to the GNSS satellite. The LPWA base station 11 can provide the GNSS assist information while including information regarding an optimal satellite according to a situation of the LPWA communication terminal 12. Thereafter, the process returns to step S2 in FIG. 8, and the processing in and after step S3 is performed using the information regarding the selected satellite.

### Operation of LPWA Communication Terminal 12

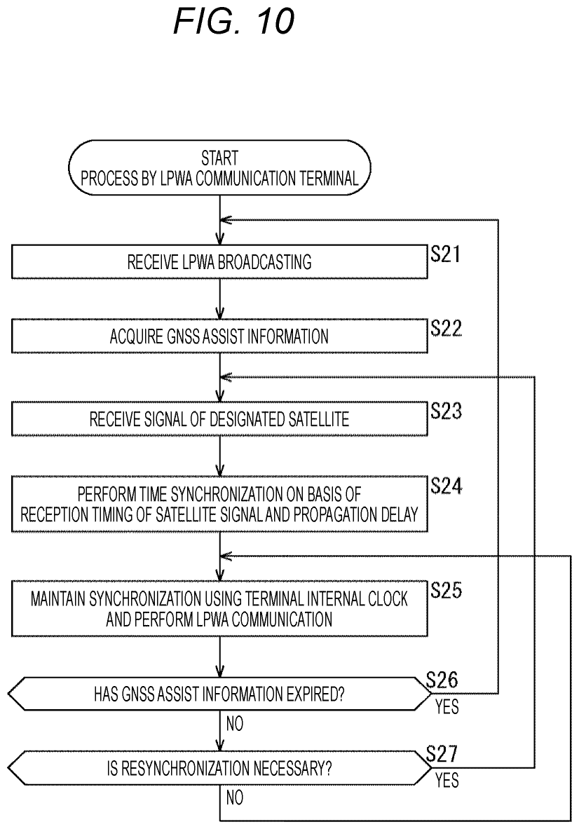

A process by the LPWA communication terminal 12 will be described with reference to a flowchart of FIG. 10.

In step S21, the LPWA communication unit 202 in FIG. 7 receives LPWA broadcasting by the LPWA base station 11.

In step S22, the GNSS assist information acquisition section 211 acquires GNSS assist information transmitted using LPWA broadcasting.

In step S23, the GNSS reception unit 203 receives a signal of a satellite designated by a satellite number included in the GNSS assist information.

In step S24, the LPWA synchronization control section 212 calculates a synchronization time on the basis of a reception timing of the satellite signal and a propagation delay included in the GNSS assist information and establishes time synchronization of LPWA communication.

In step S25, the LPWA communication unit 202 maintains synchronization using a terminal internal clock and performs LPWA communication.

In step S26, the LPWA synchronization control section 212 determines whether or not the GNSS assist information has expired. In a case where it is determined in step S26 that the GNSS assist information has expired, the process returns to step S21, and the above-described processing is repeatedly performed. Every time an expiration time of the GNSS assist information elapses, the GNSS assist information is received.

In a case where it is determined in step S26 that the GNSS assist information has not expired, in step S27, the LPWA synchronization control section 212 determines whether or not resynchronization is necessary.

In a case where it is determined in step S27 that the resynchronization is necessary, the process returns to step S23, and the subsequent processing is repeatedly performed. In a case where it is determined in step S27 that the resynchronization is not necessary, on the other hand, the process returns to step S25, and the subsequent processing is repeatedly performed.

Through the above process, the LPWA base station 11 can provide information necessary to secure time accuracy required for the LPWA communication using LPWA communication of a limited amount of transmission. In a case where conventional A-GNSS assist information is transmitted, an amount of transmission of several kB is required, but the LPWA base station 11 can provide assist information using GNSS assist information of about 20 bits.

On the other hand, even in a case where only a signal of one satellite can be received, the LPWA communication terminal 12 can establish time synchronization with accuracy required for LPWA communication, and can perform the LPWA communication. The LPWA communication terminal 12 can suppress a time error to several hundred of us or less. Depending on conditions such as the distance from the LPWA base station 11 and quantization accuracy of the propagation delay, even higher accuracy can be achieved.

The LPWA communication terminal 12 can also reduce power consumption therein. Since time synchronization can be established only by receiving a signal of one satellite, operation of a circuit of the GNSS reception unit 203, which is a GNSS reception module, can be suppressed, thereby suppressing power consumption.

Furthermore, since time synchronization can be established only by receiving a signal of one satellite, time synchronization can be established by a GNSS reception operation in a short period of time. Although acquisition of an ephemeris requires a minimum time of 18 seconds, according to the present technology, time synchronization can be established by receiving a satellite signal of 6 seconds at a beginning (cold state) and maintained by receiving a satellite signal of 0.6 seconds (reception of a TLM word) thereafter.

### Modification of First Embodiment

### Modification of GNSS Assist Information

A current time may be provided for the LPWA communication terminal 12 using LPWA broadcasting. In this case, information regarding the current time is included in the GNSS assist information. As a result, the LPWA communication terminal 12 can omit an operation of receiving a satellite signal for acquiring a time. Time until time synchronization is established can be shortened, and power consumption can be suppressed.

An expiration time of the GNSS assist information may be provided for the LPWA communication terminal 12 using LPWA broadcasting. In this case, information regarding the expiration time is included in the GNSS assist information. As a result, the LPWA communication terminal 12 can more accurately determine whether the GNSS assist information has expired. In addition, it is possible to suppress power consumption as compared with a case where a time from a satellite is used to determine an expiration.

Information regarding a Doppler frequency may be included in the GNSS assist information. As a result, the LPWA communication terminal 12 can easily start receiving the satellite signal, and can suppress power consumption. At least one of the current time, the expiration time of the GNSS assist information, and the Doppler frequency can be included in the GNSS assist information.

### Modification of Operation of LPWA Base Station 11

A satellite to be assisted (a GNSS satellite whose information is to be included in the GNSS assist information) may be selected on the basis of information acquired from a server on the Internet. This eliminates the need for the LPWA base station 11 to receive satellite signals for the selection of a satellite to be assisted. For example, information regarding an orbit of each satellite is acquired via the Internet, and a satellite to be assisted is selected on the basis of the orbit of the satellite, the position of the LPWA base station 11, and the like.

Instead of selecting one satellite as a satellite to be assisted, a plurality of satellites may be selected. In this case, information regarding a plurality of satellites is included in the GNSS assist information and provided for the LPWA communication terminal 12.

### Modification of Operation of LPWA Communication Terminal 12

The generation of the GNSS assist information may be performed by the LPWA communication terminal 12. In this case, the LPWA communication terminal 12 receives a satellite signal and generates the GNSS assist information by itself. The satellite signal is received on the basis of the GNSS assist information generated by the LPWA communication terminal 12 itself, and the time synchronization of LPWA communication is established as described above. The time synchronization of LPWA communication based on the GNSS assist information may thus be performed by a standalone operation.

The GNSS assist information may be preset in the LPWA communication terminal 12. For example, GNSS assist information according to a situation is selected from information stored in advance in a memory or the like in the LPWA communication terminal 12, and is used to establish time synchronization.

### Second Embodiment: Adaptive Control of Amount of Information of GNSS Assist Information

Although the information used to establish the time synchronization of LPWA communication is provided for the LPWA communication terminal 12 by the GNSS assist information, other information may be provided using the GNSS assist information. Content of the GNSS assist information is adaptively controlled according to a situation of the LPWA communication terminal 12.

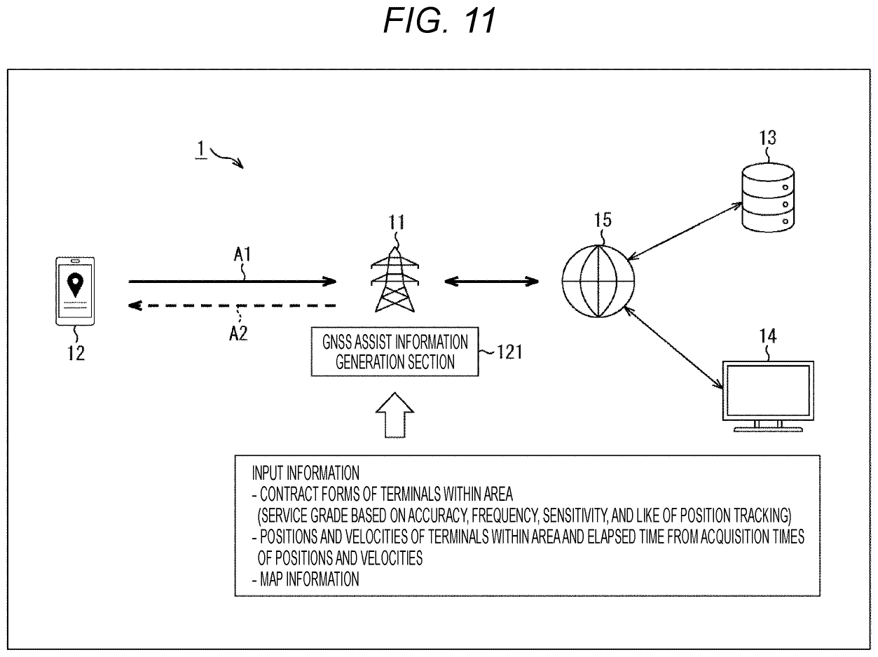

FIG. 11 is a diagram illustrating an example of adaptive control of GNSS assist information.

FIG. 11 illustrates a server 13 and a user terminal 14 connected to a network 15 such as the Internet in addition to the LPWA base station 11 and the LPWA communication terminal 12.

The server 13 is an information processing apparatus that manages information regarding LPWA communication terminals including terminals within the area of the LPWA base station 11. The LPWA communication terminal 12 is also included among the terminals within the coverage area of the LPWA base station 11. As indicated by a hollow arrow, information regarding the terminals within the area is provided as input information from the server 13 for the GNSS assist information generation section 121 of the information processing apparatus 101.

The input information includes, for example, the following information.
Contract form of terminals within area (grade of service based on accuracy/frequency/sensitivity of position tracking, etc.)
Positions and velocities of terminals within area and elapsed time from acquisition times of positions and velocities
Map information

The GNSS assist information generation section 121 sets the content of the GNSS assist information on the basis of the input information, and generates the GNSS assist information. The GNSS assist information generation section 121 transmits the generated GNSS assist information to the LPWA communication terminal 12 using downlink communication.

The user terminal 14 is a terminal such as a PC used by a user who has a contract for a service provided in the communication system 1. For example, a service for tracking the position of the LPWA communication terminal 12 is provided. A user of the user terminal 14 applies for a predetermined contract form from among contract forms prepared in advance, and uses the service. The user of the user terminal 14 can access the server 13 by operating the user terminal 14 to check a position of a person carrying the LPWA communication terminal 12 or a position of a vehicle in which the LPWA communication terminal 12 is installed.

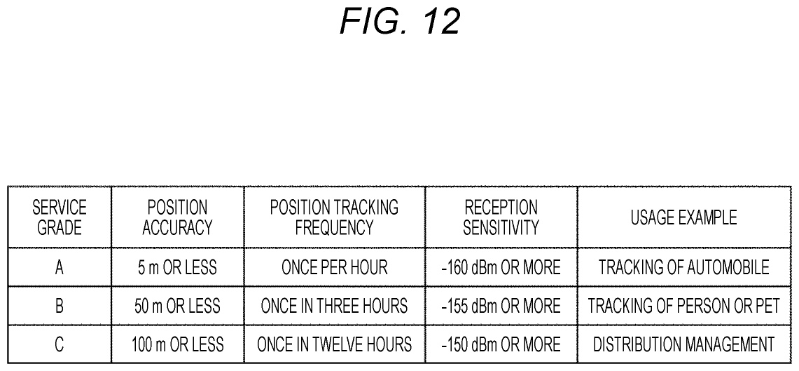

FIG. 12 is a diagram illustrating a specific example of the contract forms.

As the contract forms of the position tracking service of LPWA communication terminals, for example, a plurality of forms having different position accuracy, position tracking frequency, and satellite signal reception sensitivity are prepared. In the example of FIG. 12, contract forms of a service grade A used for tracking an automobile, a service grade B used for tracking a person or a pet, and a service grade C used for distribution management are prepared.

For example, the contract form of the service grade A is a form in which the position accuracy is 5 m or less, the position tracking frequency is once per hour, and the satellite signal reception sensitivity is −160 dBm or more. The position accuracy of 5 m or less indicates that accuracy of 5 m or less is required for positioning accuracy. The location tracking frequency of once per hour indicates that positioning is performed at a frequency of up to once per hour. The satellite signal reception sensitivity of −160 dBm or more indicates that a sensitivity of −160 dBm or more is required for the satellite signal reception sensitivity for positioning.

The contract form of the service grade B is a form in which the position accuracy is 50 m or less, the position tracking frequency is once in 3 hours, and the satellite signal reception sensitivity is −155 dBm or more. The contract form of the service grade C is a form in which the position accuracy is 100 m or less, the position tracking frequency is once in 12 hours, and the satellite signal reception sensitivity is −150 dBm or more.

Although the service grade is set according to a combination of the position accuracy, the position tracking frequency, and the satellite signal reception sensitivity, the service grade may be set according to each of the position accuracy, the position tracking frequency, and the satellite signal reception sensitivity, instead. It is possible to set the service grade according to at least one of the position accuracy, the position tracking frequency, and the satellite signal reception sensitivity. It is possible to set the service grade according to various specifications related to a reception mode of a GNSS signal other than the position accuracy, the position tracking frequency, and the satellite signal reception sensitivity.

A plurality of contract forms having different qualities is thus prepared. For example, the higher the grade, the higher the service usage amount.

### <Generation of GNSS Assist Information According to Contract Form>

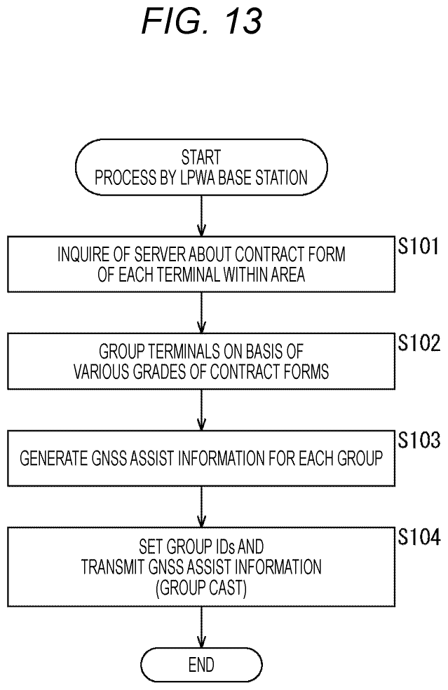

With reference to a flowchart of FIG. 13, a process by the LPWA base station 11 that generates the GNSS assist information on the basis of contract forms of terminals within the area will be described.

In step S101, the GNSS assist information generation section 121 inquires of the server 13 about a contract form of each terminal within the area. The inquiry by the GNSS assist information generation section 121 is performed, for example, by transmitting a device ID of each terminal within the area from the network communication unit 114 to the server 13. In response to the inquiry by the GNSS assist information generation section 121, information regarding the contract form of the user who tracks a position of each terminal within the area is transmitted from the server 13 to the LPWA base station 11.

In step S102, the GNSS assist information generation section 121 groups the terminals within the area on the basis of various grades of the contract forms. For example, grouping is performed in such a way as to group the terminals within the area tracked by users who have contracts of the same grade.

In step S103, the GNSS assist information generation section 121 generates GNSS assist information for each group.

In step S104, the LPWA communication unit 111 sets group IDs and transmits GNSS assist information for each group by LPWA communication. The group ID, which is identification information regarding each group, is set at a predetermined position such as a header of a packet including the GNSS assist information, and is transmitted together with the GNSS assist information. The LPWA communication terminal that has received the information transmitted from the LPWA base station 11 determines, on the basis of the group ID, whether or not the GNSS assist information is intended therefor. The transmission of the GNSS assist information in which the group ID is set is LPWA communication using a mode of group communication (group cast).

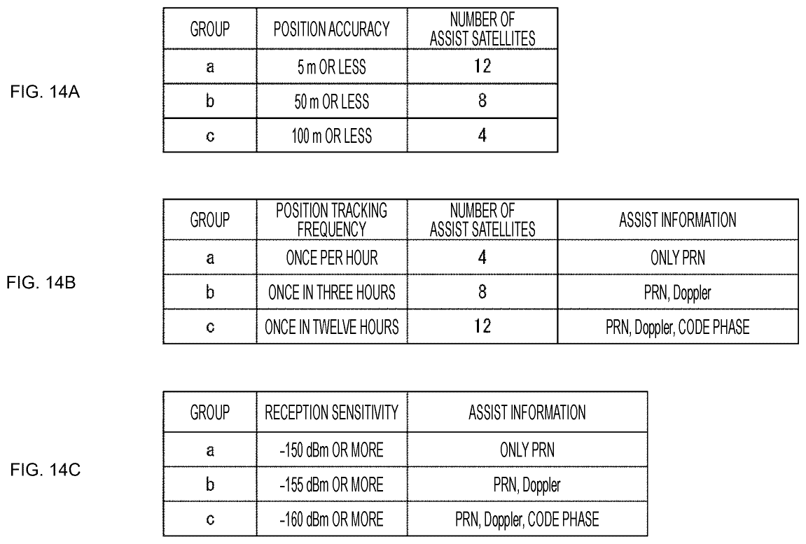

FIG. 14 is a diagram illustrating an example of GNSS assist information for each group of LPWA communication terminals.

A of FIG. 14 illustrates an example of grouping according to the position accuracy. For example, LPWA communication terminals that are targets of contract forms in which the position accuracy is 5 m or less are grouped as terminals of a group a, and LPWA communication terminals that are targets of contract forms in which the position accuracy is 50 m or less are grouped as terminals of a group b. In addition, LPWA communication terminals that are targets of contract forms in which the position accuracy is 100 m or less are grouped as terminals of a group c.

GNSS assist information for the LPWA communication terminals of the group a is generated in such a way as to include information regarding twelve satellites. In addition, GNSS assist information for the LPWA communication terminals of the group b is generated in such a way as to include information regarding eight satellites. GNSS assist information for the LPWA communication terminals of the group c is generated in such a way as to include information regarding four satellites.

In a case where the grouping is performed according to the position accuracy, information regarding more satellites is provided, using the GNSS assist information, for LPWA communication terminals that are targets of contract forms requiring higher accuracy. In general, the position accuracy improves as the number of satellites used for positioning calculation increases.

B of FIG. 14 illustrates an example of grouping according to the position tracking frequency. For example, LPWA communication terminals that are targets of contract forms in which the position tracking frequency once per hour are grouped as terminals of a group a, and LPWA communication terminals that are targets of contract forms in which the position tracking frequency is once in three hours are grouped as terminals of a group b. In addition, LPWA communication terminals that are targets of contract forms in which the position tracking frequency is once in twelve hours are grouped as terminals of a group c.

GNSS assist information for the LPWA communication terminals of the group a is generated in such a way as to include information regarding four satellites. Information regarding PRN of the four satellites is included in the GNSS assist information. In addition, GNSS assist information for the LPWA communication terminals of the group b is generated in such a way as to include information regarding eight satellites. Information regarding PRN and Doppler frequencies of the eight satellites is included in the GNSS assist information. GNSS assist information for the LPWA communication terminals of the group c is generated in such a way as to include information regarding twelve satellites. Information regarding PRN, Doppler frequencies, and code phases of the twelve satellites is included in the GNSS assist information.

In a case where the grouping is performed according to the position tracking frequency, information regarding more satellites is provided, using the GNSS assist information, for LPWA communication terminals that are targets of contract forms in which the frequency is low. By generating GNSS assist information with a small amount of information as GNSS assist information for LPWA communication terminals that are targets of contract modes in which the position tracking frequency is high, it is possible to prevent a downlink communication line from being congested.

C of FIG. 14 illustrates an example of grouping according to the satellite signal reception sensitivity. For example, LPWA communication terminals that are targets of contract forms in which the satellite signal reception sensitivity is −150 dBm or more are grouped as terminals of a group a, and LPWA communication terminals that are targets of contract forms in which the satellite signal reception sensitivity is −155 dBm or more are grouped as terminals of a group b. In addition, LPWA communication terminals that are targets of contract forms in which the satellite signal reception sensitivity is −160 dBm or more are grouped as terminals of a group c.

GNSS assist information for the LPWA communication terminals of the group a is generated in such a way as to include information regarding PRN. GNSS assist information for the LPWA communication terminals of the group b is generated in such a way as to include information regarding PRN and Doppler frequencies. GNSS assist information for the LPWA communication terminals of the group c is generated in such a way as to include information regarding PRN, Doppler frequencies, and code phases.

In a case where the grouping is performed according to the satellite signal reception sensitivity, information regarding more satellites is provided, using the GNSS assist information, for LPWA communication terminals that require high reception sensitivity. The more information is provided, the more the LPWA communication terminal can narrow down a satellite search space, allowing for a longer correlation integration time. By increasing the correlation integration time, the LPWA communication terminal can allocate operation resources for improving sensitivity.

The GNSS assist information having different amounts of information due to different types of included information is thus adaptively generated according to the situation of the contract form and provided for the LPWA communication terminal.

### <Generation of GNSS Assist Information According to Reception Environments>

The generation of the GNSS assist information can be performed on the basis of reception environments of the terminals within the area. Information having content corresponding to reception environments of satellite signals of the terminals within the area is set, and GNSS assist information is generated. GNSS assist information is generated with the reception environments of the satellite signals as the situation of the LPWA communication terminal.

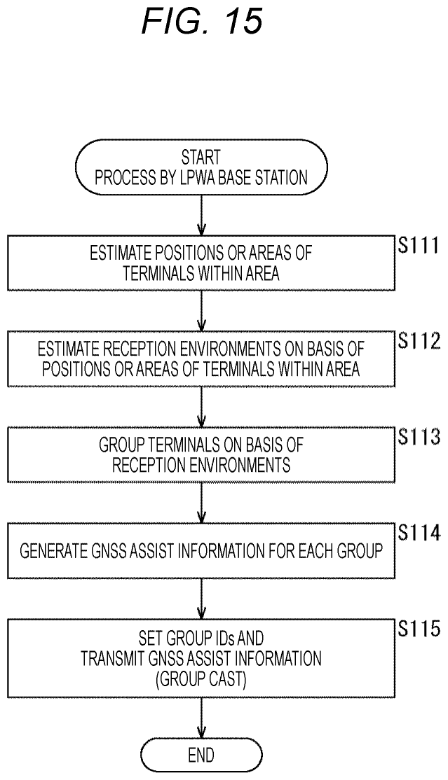

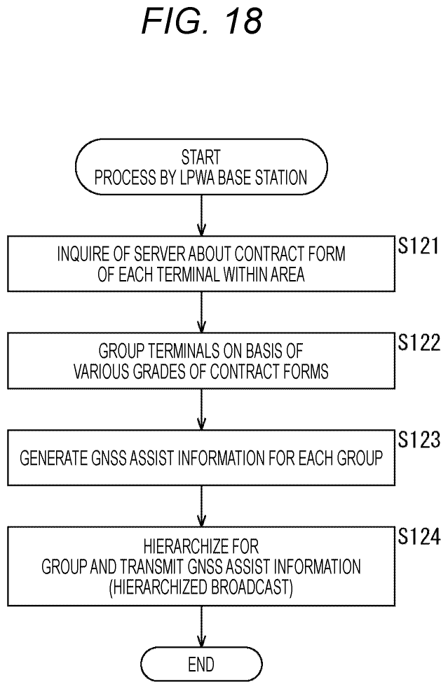

With reference to a flowchart of FIG. 15, a process by the LPWA base station 11 that generates the GNSS assist information on the basis of the reception environments of the terminals within the area will be described. Description overlapping with the above description is appropriately omitted. This is similar in FIG. 18 and other drawings referred to later.

In step S111, the GNSS assist information generation section 121 estimates positions or areas of the terminals within the area.

The positions or the areas are estimated, for example, as follows.
Estimated on the basis of the principle of triangulation by collecting information regarding reception strengths, propagation delays, and the like of a LPWA base station in the vicinity from the terminals in the area
Estimated on the basis of positions at a time of previous positioning, velocity of the LPWA communication terminal, and time elapsed from the previous positioning (estimated while assuming that the terminals within the area are each located in an area within a circle having a radius of velocity×elapsed time around the position at the time of the previous positioning)

Each area may be estimated as a range within a circle having a radius of a predetermined distance corresponding to uncertainty. A center position of each area is, for example, the position at the time of the previous positioning.

In step S112, the GNSS assist information generation section 121 estimates the reception environments on the basis of the positions or the areas of the terminals within the area.

The reception environments are estimated, for example, as follows.
Determine in advance attributes of a reception environment in each section on the basis of map information
Determine attributes of the reception environments on the basis of sections including the estimated positions or areas
Associate the base station and the reception environment on a one-to-one basis in a case where the coverage area of the base station is narrow and the reception environment in the coverage area can be regarded as a single reception environment. In this case, the GNSS assist information having the same content is provided for all the terminals within the area.

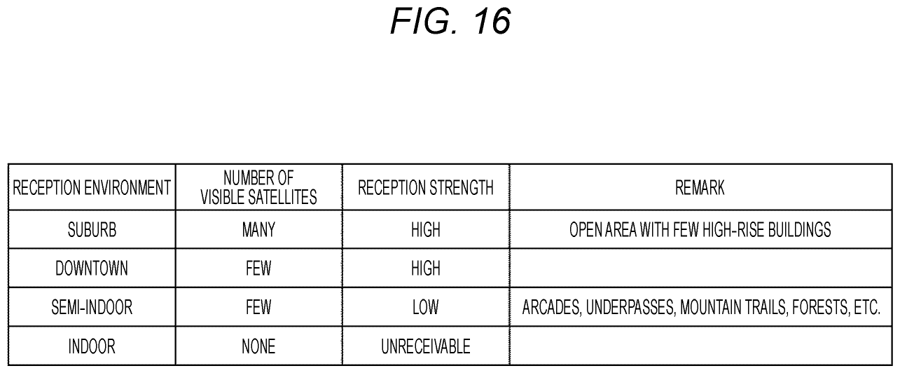

FIG. 16 is a diagram illustrating a specific example of the reception environments.

In the example of FIG. 16, four types of reception environments, namely suburb, downtown, semi-indoor, and indoor, are illustrated. The suburb is a reception environment where the number of visible satellites is large and reception strength of satellite signals is high. The downtown is a reception environment where the number of visible satellites is small and reception strength of satellite signals is high. The semi-indoor is a reception environment where the number of visible satellites is small and reception strength of satellite signals is low. The indoor is a reception environment in which there are no visible satellites and satellite signals cannot be received.

Returning to the description with reference to FIG. 15, in step S113, the GNSS assist information generation section 121 groups the terminals within the area on the basis of the reception environments. The grouping is performed in such a way as to gather terminals in the same reception environment.

In step S114, the GNSS assist information generation section 121 generates GNSS assist information for each group.

In step S115, the LPWA communication unit 111 sets group IDs and transmits GNSS assist information for each group by LPWA communication.

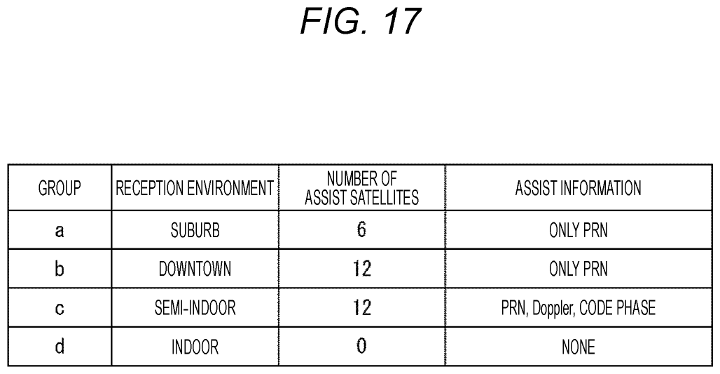

FIG. 17 is a diagram illustrating an example of the GNSS assist information for each group of LPWA communication terminals.

In the example of FIG. 17, LPWA communication terminals whose reception environment is the suburb are grouped as terminals of a group a. GNSS assist information for the LPWA communication terminals of the group a is generated in such a way as to include information regarding six satellites. Information regarding PRN of the six satellites is included in the GNSS assist information.

Since there are many visible satellites and many satellites can be seen at any viewing angle, the suburb is a reception environment in which satellites can be stably captured only by assisting information regarding some satellites. Since the reception strength of satellite signals is high, it is possible to suppress the amount of information provided as the GNSS assist information.

In addition, in the example of FIG. 17, LPWA communication terminals whose reception environment is the downtown are grouped as terminals of a group b. GNSS assist information for the LPWA communication terminals of the group b is generated in such a way as to include information regarding twelve satellites. Information regarding PRN of the twelve satellites is included in the GNSS assist information.

Since there are few visible satellites and satellites that can be seen vary depending on the position of the LPWA communication terminal, the downtown is a reception environment in which it is possible to improve a probability that satellites can be captured by assisting more satellites. Since a certain reception strength or more can be expected for satellites that can be seen, it is possible to suppress information provided as the GNSS assist information.

LPWA communication terminals whose reception environment is the semi-indoor are grouped as terminals of a group c. GNSS assist information for the LPWA communication terminals of the group c is generated in such a way as to include information regarding twelve satellites. Information regarding PRN, Doppler frequencies, and code phases of the twelve satellites is included in the GNSS assist information.

The semi-indoor is a reception environment in which there are few visible satellites and reception strength is low. By providing more information as the GNSS assist information while increasing the number of satellites to be assisted, it is possible to increase capture sensitivity.

LPWA communication terminals whose reception environment is the indoor are grouped as terminals of a group d. GNSS assist information for the LPWA communication terminals of the group d is generated in such a way as to not include information regarding satellites.

The indoor is a reception environment where it is better to avoid power consumption without performing GNSS positioning because satellite signals do not reach. Therefore, the GNSS assist information is not provided. The provision of the GNSS assist information can thus be limited according to the reception environment.

### <Hierarchized Broadcast>

The GNSS assist information for each group may be hierarchized, and the GNSS assist information of all layers may be broadcast to all the terminals in the area. Each LPWA communication terminal that has received the hierarchized GNSS assist information acquires the GNSS assist information according to a layer thereof and uses the GNSS assist information for reception of satellite signals and the like.

With reference to a flowchart of FIG. 18, a process by the LPWA base station 11 that transmits the hierarchized GNSS assist information will be described.

In step S121, the GNSS assist information generation section 121 inquires of the server 13 about the contract form of each terminal within the area.

In step S122, the GNSS assist information generation section 121 groups the terminals within the area on the basis of various grades of the contract forms.

In step S123, the GNSS assist information generation section 121 generates GNSS assist information for each group.

In step S124, the LPWA communication unit 111 sets a group ID for the GNSS assist information of each group, hierarchizes the GNSS assist information, and transmits the hierarchized GNSS assist information by LPWA communication. The LPWA communication terminal receives the GNSS assist information in a layer thereof. Each LPWA communication terminal is notified in advance of information indicating a layer of GNSS assist information to be received using an individual line of LPWA communication or a common line.

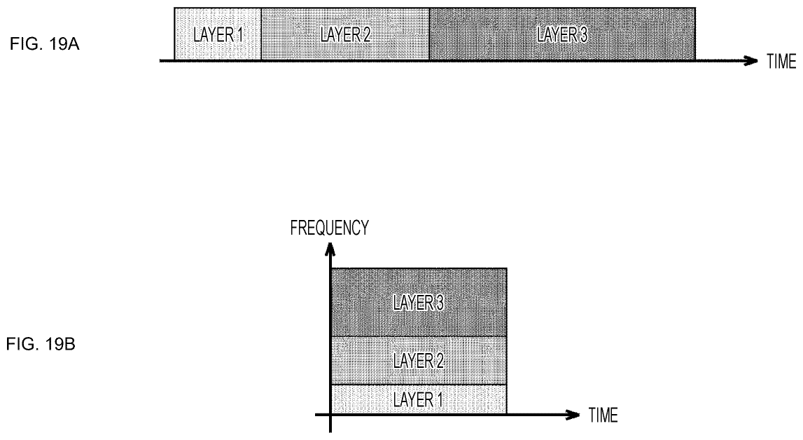

FIG. 19 is a diagram illustrating an example of transmission of the hierarchized GNSS assist information.

A of FIG. 19 illustrates an example of transmission of GNSS assist information hierarchized in a time direction. In the example in A of FIG. 19, the GNSS assist information of layer 1, layer 2, and layer 3 is transmitted in this order. A fact that time required for transmission of the GNSS assist information of layer 1 is short indicates that the amount of information of the GNSS assist information of layer 1 is smaller than the amount of information of the GNSS assist information of layers 2 and 3.

B of FIG. 19 illustrates an example of transmission of GNSS assist information hierarchized in a frequency direction. In the example in B of FIG. 19, a predetermined frequency band is allocated to GNSS assist information of each of layer 1, layer 2, and layer 3, and transmission is performed. A fact that the frequency band allocated to the GNSS assist information of layer 1 is narrow indicates that the amount of information of the GNSS assist information of layer 1 is smaller than the amount of information of the GNSS assist information of layers 2 and 3.

The GNSS assist information may thus be transmitted after being hierarchized in the time direction or in the frequency direction. The GNSS assist information of each layer is collectively transmitted in a form in which a group ID designating target LPWA communication terminals is added.

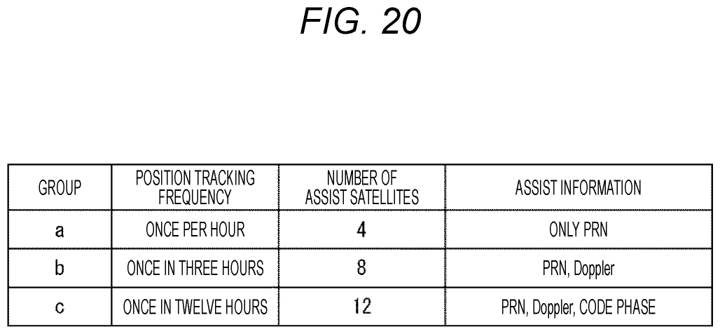

FIG. 20 is a diagram illustrating an example of the GNSS assist information for each group of LPWA communication terminals.

FIG. 20 illustrates an example of a case where grouping is performed in accordance with the position tracking frequency. Content of the GNSS assist information illustrated in FIG. 20 is the same as the content described with reference to B of FIG. 14. Redundant description is omitted as appropriate. For example, LPWA communication terminals that are targets of contract forms in which the position tracking frequency is once per hour are grouped as terminals of a group a. GNSS assist information for the LPWA communication terminals of the group a is generated in such a way as to include information regarding PRN of four satellites.

For example, the GNSS assist information of each layer is generated in such a way as to include the following information.
Layer 1: PRN of satellites 1 to 4
Layer 2: PRN of satellites 5 to 8 and Doppler frequencies of satellites 1 to 8
Layer 3: PRN of satellites 9 to 12, Doppler frequencies of satellites 9 to 12, and code phases of satellites 1 to 12

For example, in the LPWA communication terminals of each group, reception processing is performed in such a way as to receive the GNSS assist information of the following layer(s).
Group a: Receive layer 1
Group b: Receive layers 1 and 2
Group c: Receive layers 1 to 3

### <Configuration and Operation of LPWA Communication Terminal>

### Configuration of LPWA Communication Terminal 12

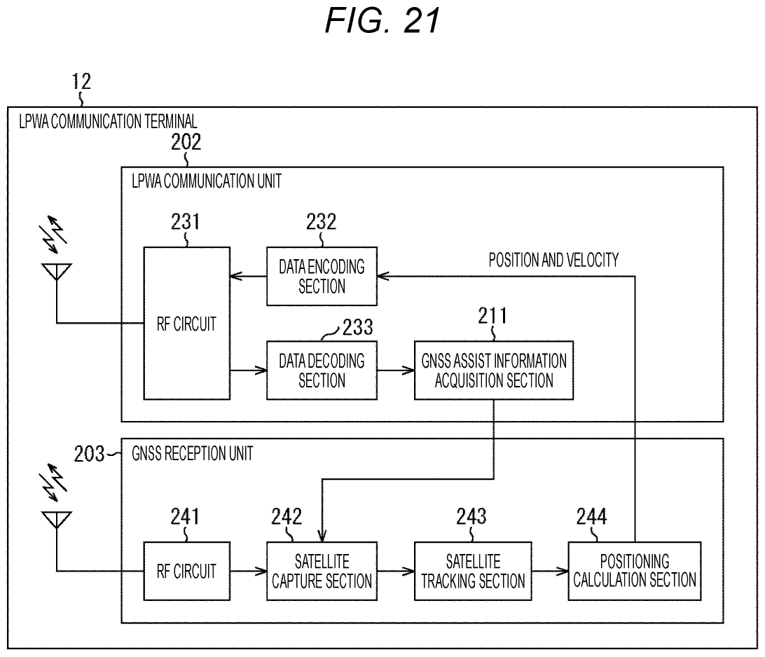

FIG. 21 is a block diagram illustrating another configuration example of the LPWA communication terminal 12.

In the configuration of the LPWA communication terminal 12 illustrated in FIG. 21, the same components as those described with reference to FIG. 7 are denoted by the same reference numerals. Redundant description is omitted as appropriate. The configuration of the LPWA communication terminal 12 illustrated in FIG. 21 is different from the configuration illustrated in FIG. 7 in that the control unit 201 is not provided.

The LPWA communication unit 202 includes a GNSS assist information acquisition section 211, an RF circuit 231, a data encoding section 232, and a data decoding section 233. The GNSS assist information acquisition section 211 can be provided in the LPWA communication unit 202.

The RF circuit 231 receives a radio wave of LPWA communication and performs signal processing such as A/D conversion processing and demodulation processing on a received signal. Data generated by the signal processing by the RF circuit 231 is output to the data decoding section 233. Furthermore, the RF circuit 231 performs signal processing such as modulation processing and D/A conversion processing on transmission data supplied from the data encoding section 232, and transmits, using uplink communication, the transmission data obtained by performing the signal processing.

The data encoding section 232 performs encoding processing on data such as a position and velocity supplied from a positioning calculation section 244, and outputs transmission data obtained by performing the encoding processing to the RF circuit 231.

The data decoding section 233 performs decoding processing on the data supplied from the RF circuit 231, and outputs received data obtained by performing the decoding processing to the GNSS assist information acquisition section 211.

The GNSS assist information acquisition section 211 extracts and acquires GNSS assist information from the received data supplied from the data decoding section 233. The GNSS assist information acquired by the GNSS assist information acquisition section 211 is supplied to a satellite capture section 242 of the GNSS reception unit 203.

The GNSS reception unit 203 includes an RF circuit 241, the satellite capture section 242, a satellite tracking section 243, and the positioning calculation section 244.

The RF circuit 241 receives a radio wave from a satellite and performs signal processing such as A/D conversion processing and demodulation processing on a received signal. Data generated by the signal processing by the RF circuit 241 is output to the satellite capture section 242.

The satellite capture section 242 captures the satellite by correlating the data supplied from the RF circuit 241 with a satellite unique code. For capturing a satellite by the satellite capture section 242, information included in the GNSS assist information supplied from the GNSS assist information acquisition section 211 is appropriately used. In a case where there is no GNSS assist information or backup information, processing for two-dimensionally searching Doppler frequencies and code phases is performed for all satellite unique codes defined by a standard. A satellite signal generated by the signal processing by the satellite capture section 242 is supplied to the satellite tracking section 243.

The satellite tracking section 243 synchronizes a carrier frequency, a code phase, and a transmission frame, and decodes a transmission time of a signal from each satellite and satellite orbit information. The information acquired by the satellite tracking section 243 is supplied to the positioning calculation section 244.

The positioning calculation section 244 performs positioning calculation on the basis of the information supplied from the satellite tracking section 243, and obtains a time and a position. For example, the positioning calculation section 244 obtains the time and the position by solving simultaneous equations based on four or more satellite times and satellite positions using a time and a three-dimensional position in the GNSS reception unit 203 as a reception module as variables. In addition, the positioning calculation section 244 obtains a TCXO offset and a velocity by solving simultaneous equations based on carrier frequency offsets and satellite velocities of four or more satellites using the TCXO offset and a three-dimensional velocity as variables. The satellite positions and the satellite velocities are calculated from orbit information. Information regarding the position and the velocity obtained by the positioning calculation section 244 is supplied to the data encoding section 232 of the LPWA communication unit 202.

The satellite time and the carrier frequency offset of each satellite output by the satellite tracking section 243 may be transmitted to the LPWA base station 11 as they are, and positioning calculation may be performed on an LPWA base station 11 side. In this case, since it is not necessary to decode the satellite orbit information, operation time of the GNSS reception unit 203 can be shortened, and the power consumption of the LPWA communication terminal 12 can be suppressed.

### Operation of LPWA Communication Terminal 12

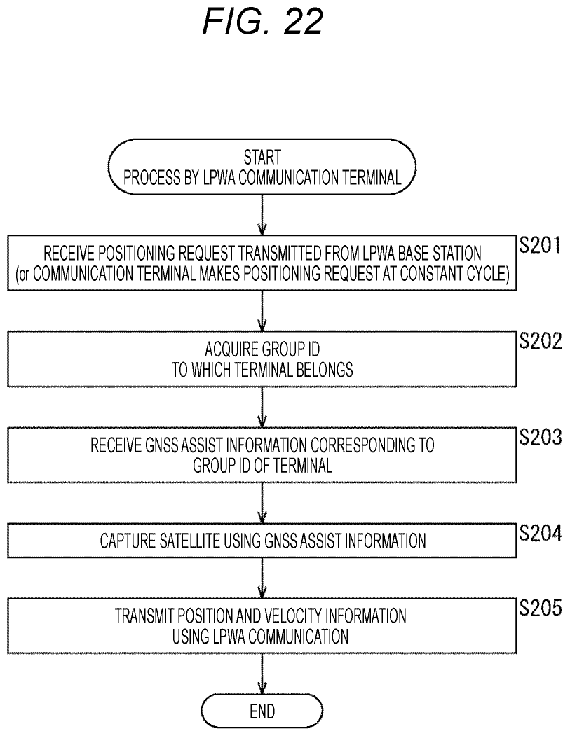

A process by the LPWA communication terminal 12 having the configuration illustrated in FIG. 21 will be described with reference to a flowchart of FIG. 22.

In step S201, for example, the data decoding section 233 of the LPWA communication unit 202 receives a positioning request transmitted from the LPWA base station 11. For example, the positioning request acquired by the data decoding section 233 by performing decoding processing is supplied to the GNSS reception unit 203 via a path (not illustrated). The LPWA communication terminal 12 may make a positioning request to the GNSS reception unit 203 at a constant cycle. The GNSS reception unit 203 is activated with the positioning request as a trigger, and performs a series of processing steps including satellite capture, satellite tracking, and positioning calculation.

In step S202, the data decoding section 233 acquires a group ID to which the terminal belongs. The group ID is notified of from the LPWA base station 11 through an individual line or the like as described above. Table information in which a device ID and a group ID are associated with each other may be notified of using LPWA broadcasting.

In step S203, the GNSS assist information acquisition section 211 receives GNSS assist information corresponding to the group ID of the terminal. The GNSS assist information acquired by the GNSS assist information acquisition section 211 is supplied to the satellite capture section 242.

In step S204, the satellite capture section 242 captures a satellite using information included in the GNSS assist information. In a case where information regarding PRN, which is an identification number of a satellite unique code, is included in the GNSS assist information, it is possible to limit satellites to be searched. Furthermore, in a case where information regarding a Doppler frequency is included in the GNSS assist information, a search range of the carrier frequency can be limited. In a case where information regarding a code phase is included in the GNSS assist information, a search range of the code phase can be limited.

Positioning calculation is performed by the positioning calculation section 244 on the basis of a signal of the satellite captured by the satellite capture section 242, and a position and a velocity are obtained. Information regarding the position and the velocity obtained by the positioning calculation section 244 is supplied to the data encoding section 232 of the LPWA communication unit 202 and supplied to the RF circuit 231 as transmission data.

In step S205, the LPWA communication unit 202 transmits the information regarding the position and the velocity using LPWA communication.

As described above, in the communication system 1, the GNSS assist information is provided using a minimum amount of transmission according to the reception environment of the LPWA communication terminal, required position accuracy, and the like. Even in low-power communication such as LPWA communication, it is possible to efficiently achieve assistance of information necessary for reception of a satellite signal.

### <<Others>>

### <Configuration Example of Computer>

The series of processing steps described above may be executed by hardware, or may be executed by software. In a case where the series of processing steps is executed by software, a program included in the software is installed from a program recording medium on a computer incorporated in dedicated hardware, a general-purpose personal computer, or the like.

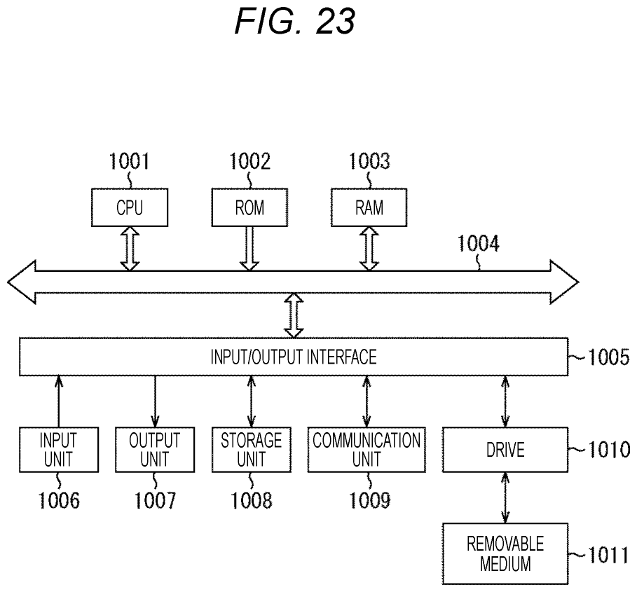

FIG. 23 is a block diagram illustrating a configuration example of hardware of a computer that performs the above-described series of processing steps by a program. The user terminal 14, the information processing apparatus 101, and the like are achieved by a computer having the configuration illustrated in FIG. 23.

A central processing unit (CPU) 1001, a read only memory (ROM) 1002, and a random access memory (RAM) 1003 are connected to one another via a bus 1004.

An input/output interface 1005 is further connected to the bus 1004. The input/output interface 1005 is connected with an input unit 1006 including, for example, a keyboard and a mouse, and an output unit 1007 including, for example, a display and a speaker. Furthermore, the input/output interface 1005 is connected with a storage unit 1008 including, for example, a hard disk and a non-volatile memory, a communication unit 1009 including, for example, a network interface, and a drive 1010 driving a removable medium 1011.

In the computer configured as described above, for example, the CPU 1001 loads a program stored in the storage unit 1008 into the RAM 1003 via the input/output interface 1005 and the bus 1004 and executes the program, to perform the series of the processing described above.

For example, the program to be executed by the CPU 1001 is recorded in the removable medium 1011 or provided via a wired or wireless transmission medium such as a local area network, the Internet, or a digital broadcast, and installed in the storage unit 1008.

The program executed by the computer may be a program in which the processing is performed in time series in the order described in the present description, or may be a program in which the processing is performed in parallel or at a necessary timing such as when a call is made.

In the present description, a system means a set of a plurality of constituent elements (apparatuses, modules (parts), and the like), and it does not matter whether or not all the constituent elements are placed in the same housing. Thus, a plurality of devices housed in separate housings and connected to each other via a network and one device in which a plurality of modules is housed in one housing are both the systems.

The effects described in the present specification are merely examples and are not limited, and other effects may be provided.

The embodiment of the present technology is not limited to the embodiments described above, and various modifications can be made without departing from the scope of the present technology.

For example, the present technology can have a configuration of cloud computing in which one function is shared and processed in cooperation by a plurality of devices via a network.

In addition, each step described in the flowcharts described above can be executed by one apparatus or can be shared and executed by a plurality of apparatuses.

Moreover, in a case where one step includes a plurality of processing steps, the plurality of processing steps included in the step can be performed by a one device or performed by a plurality of devices in a shared manner.

### <Combination Examples of Configuration>

The present technology can also be configured as follows.

(1)

An information processing apparatus including:
a generation unit that generates GNSS assist information that is used in an LPWA communication terminal to receive a satellite signal and that includes information according to a situation of the LPWA communication terminal; and
an LPWA communication unit that transmits the GNSS assist information to the LPWA communication terminal within an area using LPWA communication.
   (2)

The information processing apparatus according to (1), in which
the generation unit generates the GNSS assist information including a satellite number of a GNSS satellite that is a reception target of a satellite signal and information regarding a propagation delay of a satellite signal transmitted by the GNSS satellite designated by the satellite number.
   (3)

The information processing apparatus according to (2), in which
the generation unit generates the GNSS assist information further including information regarding at least one of a current time, an expiration time of the GNSS assist information, and a Doppler frequency.
   (4)

The information processing apparatus according to any one of (1) to (3), in which
the generation unit generates the GNSS assist information used in the LPWA communication terminal in a situation of establishing time synchronization of LPWA communication.
   (5)

The information processing apparatus according to any one of (1) to (4), in which
the generation unit selects a GNSS satellite whose information is to be included in the GNSS assist information on the basis of at least one of a reception state of a satellite signal, an elevation angle of a GNSS satellite, and a degree of change in a distance to the GNSS satellite.
   (6)

The information processing apparatus according to (5), further including:
a GNSS reception unit that receives a satellite signal, in which
the generation unit selects a GNSS satellite whose information is to be included in the GNSS assist information from among GNSS satellites from which the GNSS reception unit can receive a satellite signal.
   (7)

The information processing apparatus according to (1), in which
the generation unit generates the GNSS assist information having a different amount of information according to the situation of the LPWA communication terminal.
   (8)

The information processing apparatus according to (7), in which
the generation unit generates the GNSS assist information including information regarding at least any one of a satellite number, a Doppler frequency, and a code phase of a GNSS satellite from which a satellite signal is to be received.
   (9)

The information processing apparatus according to (7), in which
the generation unit generates the GNSS assist information including information according to at least one of required positioning accuracy, a positioning frequency, and satellite signal reception sensitivity as the situation of the LPWA communication terminal.
   (10)

The information processing apparatus according to (7), in which
the generation unit generates the GNSS assist information including information according to a satellite signal reception environment as the situation of the LPWA communication terminal.
   (11)

The information processing apparatus according to any one of (1) to (10), in which
the LPWA communication unit collectively transmits a plurality of pieces of the GNSS assist information to which identification information designating a group of the target LPWA communication terminals is added.
   (12)

An information processing method performed by an information processing apparatus,
the information processing method including:
generating GNSS assist information that is used in an LPWA communication terminal to receive a satellite signal and that includes information according to a situation of the LPWA communication terminal; and
transmitting the GNSS assist information to the LPWA communication terminal within an area using LPWA communication.
   (13)

A program causing a computer
to perform a process of:
generating GNSS assist information that is used in an LPWA communication terminal to receive a satellite signal and that includes information according to a situation of the LPWA communication terminal; and
transmitting the GNSS assist information to the LPWA communication terminal within an area using LPWA communication.
   (14)

An LPWA communication terminal including:
an LPWA communication unit that receives GNSS assist information generated in an LPWA base station in such a way as to include information according to a situation of an LPWA communication terminal and transmitted by the LPWA base station using LPWA communication; and
a GNSS reception unit that receives a satellite signal on the basis of information included in the GNSS assist information.
   (15)

The LPWA communication terminal according to (14), in which
the GNSS reception unit receives a satellite signal of a GNSS satellite designated by a satellite number included in the GNSS assist information.
   (16)

The LPWA communication terminal according to (15), in which
the LPWA communication unit establishes time synchronization of LPWA communication with the LPWA base station on the basis of a time obtained on the basis of a reception timing of the satellite signal and a propagation delay indicated by information included in the GNSS assist information.
   (17)

The LPWA communication terminal according to any one of (14) to (16), in which
the LPWA communication unit receives the GNSS assist information transmitted by the LPWA base station every time an expiration time of the GNSS assist information elapses.
   (18)

A communication method performed by an LPWA communication terminal,
the communication method including:
receiving GNSS assist information generated in an LPWA base station in such a way as to include information according to a situation of the LPWA communication terminal and transmitted by the LPWA base station using LPWA communication; and
receiving a satellite signal on the basis of information included in the GNSS assist information.
   (19)

A program causing a computer
to perform a process of:
receiving GNSS assist information generated in an LPWA base station in such a way as to include information according to a situation of an LPWA communication terminal and transmitted by the LPWA base station using LPWA communication; and
receiving a satellite signal on the basis of information included in the GNSS assist information.
   (20)

An LPWA communication terminal including:
a generation unit that generates GNSS assist information used to receive a satellite signal and including information according to a situation of the LPWA communication terminal;
a GNSS reception unit that receives a satellite signal on the basis of information included in the GNSS assist information; and
an LPWA communication unit that performs LPWA communication with an LPWA base station.

### REFERENCE SIGNS LIST

1 Communication system
11 LPWA base station
12 Communication terminal
13 Server
14 User terminal
15 Network
101 Information processing apparatus
111 LPWA communication unit
112 GNSS reception unit
113 Control unit
114 Network communication unit
121 GNSS assist information generation section
201 Control unit
202 LPWA communication unit
10 203 GNSS reception unit
211 GNSS assist information generation section
212 LPWA synchronization control section

1. An information processing apparatus comprising:
a generation unit that generates GNSS assist information that is used in an LPWA communication terminal to receive a satellite signal and that includes information according to a situation of the LPWA communication terminal; and
an LPWA communication unit that transmits the GNSS assist information to the LPWA communication terminal within an area using LPWA communication.

2. The information processing apparatus according to claim 1, wherein
the generation unit generates the GNSS assist information including a satellite number of a GNSS satellite that is a reception target of a satellite signal and information regarding a propagation delay of a satellite signal transmitted by the GNSS satellite designated by the satellite number.

3. The information processing apparatus according to claim 2, wherein
the generation unit generates the GNSS assist information further including information regarding at least one of a current time, an expiration time of the GNSS assist information, and a Doppler frequency.

4. The information processing apparatus according to claim 1, wherein
the generation unit generates the GNSS assist information used in the LPWA communication terminal in a situation of establishing time synchronization of LPWA communication.

5. The information processing apparatus according to claim 1, wherein
the generation unit selects a GNSS satellite whose information is to be included in the GNSS assist information on a basis of at least one of a reception state of a satellite signal, an elevation angle of a GNSS satellite, and a degree of change in a distance to the GNSS satellite.

6. The information processing apparatus according to claim 5, further comprising:
a GNSS reception unit that receives a satellite signal, wherein
the generation unit selects a GNSS satellite whose information is to be included in the GNSS assist information from among GNSS satellites from which the GNSS reception unit can receive a satellite signal.

7. The information processing apparatus according to claim 1, wherein
the generation unit generates the GNSS assist information having a different amount of information according to the situation of the LPWA communication terminal.

8. The information processing apparatus according to claim 7, wherein
the generation unit generates the GNSS assist information including information regarding at least any one of a satellite number, a Doppler frequency, and a code phase of a GNSS satellite from which a satellite signal is to be received.

9. The information processing apparatus according to claim 7, wherein
the generation unit generates the GNSS assist information including information according to at least one of required positioning accuracy, a positioning frequency, and satellite signal reception sensitivity as the situation of the LPWA communication terminal.

10. The information processing apparatus according to claim 7, wherein
the generation unit generates the GNSS assist information including information according to a satellite signal reception environment as the situation of the LPWA communication terminal.

11. The information processing apparatus according to claim 1, wherein
the LPWA communication unit collectively transmits a plurality of pieces of the GNSS assist information to which identification information designating a group of the target LPWA communication terminals is added.

12. An information processing method performed by an information processing apparatus,
the information processing method comprising:
generating GNSS assist information that is used in an LPWA communication terminal to receive a satellite signal and that includes information according to a situation of the LPWA communication terminal; and
transmitting the GNSS assist information to the LPWA communication terminal within an area using LPWA communication.

13. A program causing a computer
to perform a process of:
generating GNSS assist information that is used in an LPWA communication terminal to receive a satellite signal and that includes information according to a situation of the LPWA communication terminal; and
transmitting the GNSS assist information to the LPWA communication terminal within an area using LPWA communication.

14. An LPWA communication terminal comprising:
an LPWA communication unit that receives GNSS assist information generated in an LPWA base station in such a way as to include information according to a situation of an LPWA communication terminal and transmitted by the LPWA base station using LPWA communication; and
a GNSS reception unit that receives a satellite signal on a basis of information included in the GNSS assist information.

15. The LPWA communication terminal according to claim 14, wherein
the GNSS reception unit receives a satellite signal of a GNSS satellite designated by a satellite number included in the GNSS assist information.

16. The LPWA communication terminal according to claim 15, wherein
the LPWA communication unit establishes time synchronization of LPWA communication with the LPWA base station on a basis of a time obtained on a basis of a reception timing of the satellite signal and a propagation delay indicated by information included in the GNSS assist information.

17. The LPWA communication terminal according to claim 14, wherein
the LPWA communication unit receives the GNSS assist information transmitted by the LPWA base station every time an expiration time of the GNSS assist information elapses.

18. A communication method performed by an LPWA communication terminal,
the communication method comprising:
receiving GNSS assist information generated in an LPWA base station in such a way as to include information according to a situation of the LPWA communication terminal and transmitted by the LPWA base station using LPWA communication; and
receiving a satellite signal on a basis of information included in the GNSS assist information.

19. A program causing a computer
to perform a process of:
receiving GNSS assist information generated in an LPWA base station in such a way as to include information according to a situation of an LPWA communication terminal and transmitted by the LPWA base station using LPWA communication; and
receiving a satellite signal on a basis of information included in the GNSS assist information.

20. An LPWA communication terminal comprising:
a generation unit that generates GNSS assist information used to receive a satellite signal and including information according to a situation of the LPWA communication terminal;
a GNSS reception unit that receives a satellite signal on a basis of information included in the GNSS assist information; and
an LPWA communication unit that performs LPWA communication with an LPWA base station.
